(19) United States
(12) Patent Application Publication
(10) Pub. No.: US 2016/0248625 A1
(43) Pub. Date: Aug. 25, 2016

(54) DISTRIBUTOR PRIVATE CLOUD MANAGEMENT SYSTEM AND MANAGEMENT METHOD

(71) Applicant: Aether Services, Taiwan, Ltd., Hsinchu City (TW)

(72) Inventors: Chun-Yuan LEE, Zhudong Township (TW); Chen-Chia TSAI, Zhubei City (TW); Ying-Peng WU, Zhubei City (TW)

(21) Appl. No.: 14/716,465

(22) Filed: May 19, 2015

(30) Foreign Application Priority Data
Feb. 25, 2015 (CN) 201510087107.9

(51) Int. Cl. H04L 12/24; H04L 12/46; H04L 29/08

(52) U.S. Cl. CPC H04L 41/084; H04L 67/10; H04L 12/4641

(57) ABSTRACT

A distributor private cloud management system and a management method are provided. The system includes a public cloud management device and a cluster device that provides a public cloud network. The public cloud management device plans, in the public cloud network according to distributor private cloud setting information input externally, a virtual private cloud network corresponding to the distributor private cloud setting information, and defines a private resource apparatus controlled and managed by the virtual private cloud network among network resource apparatuses included by the public cloud network. The present disclosure can properly improve a positioning and function of a distributor in a cloud service mechanism, and highlight value of the distributor in a cloud service.

### CROSS-REFERENCE TO RELATED APPLICATION

This application claims the benefit of China Patent Application No. 201510087107.9, filed on Feb. 25, 2015, which is hereby incorporated by reference for all purposes as if fully set forth herein.

### BACKGROUND

1. Technical Field

The present invention relates to a cloud management system, and in particular, to a distributor private cloud management system and management method.

2. Related Art

In current technologies, most commercial cloud services use a business to customer (B2C) model, that is, an enterprise to customer e-commerce model, where an enterprise is either a brand manufacturer or a telecom operator, and so do a general commercial cloud service and an Internet of Things cloud service.

However, this type of cloud service is generally not suitable for a mechanism that needs to coordinate with a physical local service. This physical local service can only be implemented by using a relevant supporting service mechanism provided by a conventional channel distributor (referred to as a distributor hereinafter).

Moreover, the Internet of Things cloud service not only requires a cloud virtual service, but also needs conventional information technology (IT) physical channel services such as pre-sales training, mounting and accommodation configuration, and after-sales maintenance. Activities of conventional channel distribution systems need to be combined in the market, so as to form a cloud service system in which the virtual and the real are combined.

However, the distributor does not have a clear positioning and function in terms of implementation of a cloud service mechanism, the whole cloud service system, and even an existing e-commerce model. Therefore, value and importance of the distributor in the cloud service cannot be accumulated and highlighted, thereby causing a failure in implementation of this type of value-added cloud service.

### SUMMARY

To solve the above problems, a major objective of the present invention is to provide a distributor private cloud management system and management method, where a private cloud of a distributor is constructed on a public cloud, so that the distributor shows, by using the private cloud, value and importance thereof in a cloud service.

To achieve the above objective, the distributor private cloud management system disclosed in the present invention includes a cluster device and a public cloud management device. The public cloud management device manages a public cloud network provided by the cluster device. The public cloud network includes a plurality of network resource apparatuses. The public cloud management device plans, in the public cloud network according to distributor private cloud setting information input externally, a virtual private cloud network corresponding to the distributor private cloud setting information, and defines a private resource apparatus controlled and managed by the virtual private cloud network among the network resource apparatuses.

The distributor private cloud management method disclosed in the present invention is applicable to a public cloud management device, and is used to manage a public cloud network provided by a cluster device, where the public cloud network includes a plurality of network resource apparatuses. The method includes: planning, by the public cloud management device in the public cloud network according to distributor private cloud setting information input externally, a virtual private cloud network corresponding to the distributor private cloud setting information; and defining, by the public cloud management device, a private resource apparatus controlled and managed by the virtual private cloud network among the network resource apparatuses.

The present invention is characterized in that it can properly improve a positioning and function of a distributor in a cloud service mechanism, and highlight value of the distributor in a cloud service. Moreover, a distributor can mount, to a private cloud of the distributor, a network device served by the distributor, so that the distributor can effectively serve clients, and accumulate customer sources, or further provide or develop relevant peripheral services or products for commodities, to perform a function of secondary sales or increase secondary value of the commodities after development, so as to differ from other distributors. For example, the public cloud management device may provide a web page application programming interface (web api) for the distributor to perform secondary development. The distributor may develop, based on this application programming interface, a required mobile application (mobile app, app), a web page application, a window application (windows app), or any software program. Further, in addition to distributors, an applicant of a private cloud may be any private enterprise or any person having this requirement, which can plan, in a public cloud, an exclusive virtual private cloud, and set a cloud communication portal, an identification symbol (logo) and managed devices on the virtual private cloud, thereby helping improve applicability of the present invention.

### BRIEF DESCRIPTION OF THE DRAWINGS

The invention will become more fully understood from the detailed description given herein below for illustration only, and thus are not limitative of the invention, and wherein:

FIG. 1 is a schematic architectural diagram of a management system according to an embodiment of the present invention;

FIG. 2 is a schematic flowchart of a management method according to an embodiment of the present invention; and

FIG. 3 is a schematic diagram of an apparatus management interface according to an embodiment of the present invention.

### DESCRIPTIONS OF REFERENCE NUMERALS

100 Distributor terminal apparatus
101 User terminal apparatus
200 Public cloud management device
210 Public cloud network
211a, 211b, 211c, 211d, 211e, 211f, 211g Network resource apparatus
220 Virtual private cloud network
230 Management interface
300 Cluster device
Steps S110 to S120.

### DETAILED DESCRIPTION

To further understand the objectives, characteristics, structural features and functions of the present invention, detailed descriptions are made as follows in combination with relevant embodiments and accompanying drawings.

Refer to a schematic architectural diagram of a management system according to an embodiment of the present invention. The system architecture includes terminal apparatuses, a public cloud management device 200, and a cluster device 300. The cluster device 300 is formed by a server group constructed in a cluster, and is configured to provide a public cloud network 210. The public cloud management device 200 manages the public cloud network 210, and the public cloud network 210 includes a plurality of network resource apparatuses. The terminal apparatuses may be connected to the public cloud management device 200 in any network communication manner. A terminal apparatus may be a distributor network management apparatus, or a client apparatus of a general client. For the convenience of description, the terminal apparatuses are distinguished as a distributor terminal apparatus 100 and a user terminal apparatus 101.

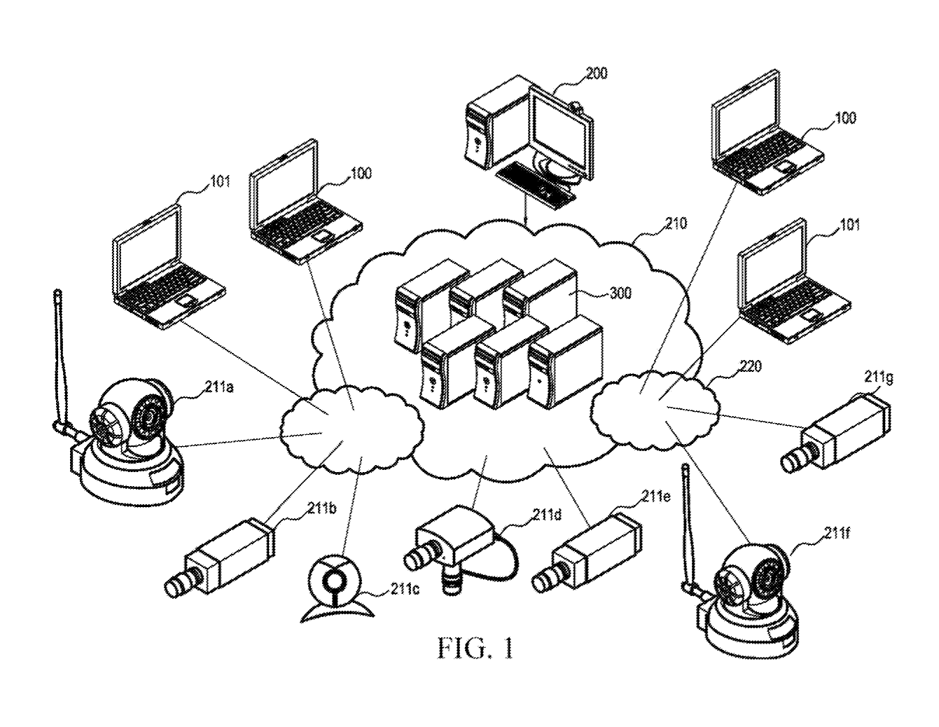

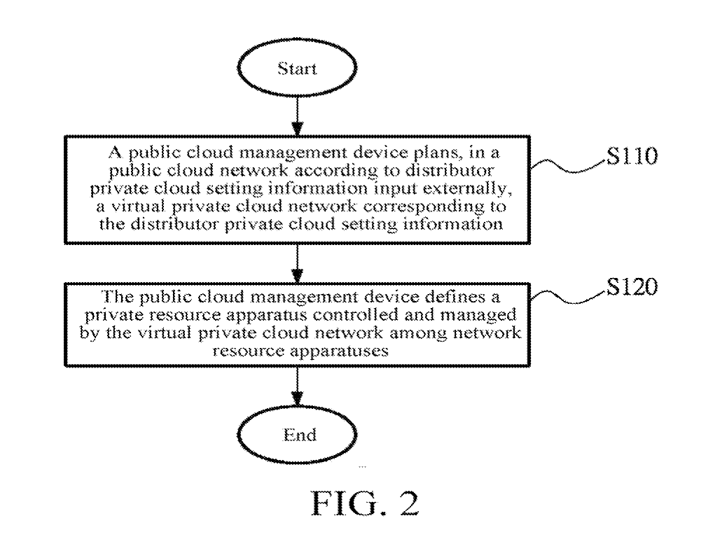

Further refer to FIG. 2, which is a schematic flowchart of a management method according to an embodiment of the present invention, and shows a management and construction process of a distributor private cloud of the system shown in FIG. 1. The method at least includes the following steps:

A public cloud management device 200 plans, in a public cloud network 210 according to distributor private cloud setting information input externally, a virtual private cloud network 220 corresponding to the distributor private cloud setting information (step S110).

In this step, an applicant of a private cloud (for example, a distributor) may operate a distributor terminal apparatus 100 and input data in the distributor terminal apparatus 100, so that the distributor terminal apparatus 100 submits a piece of distributor private cloud setting information to the public cloud management device 200. In some embodiments, the applicant of the private cloud may submit the distributor private cloud setting information to an owner of the public cloud management device 200 in any manner, which is not limited to using the distributor terminal apparatus 100. The distributor private cloud setting information provides a private cloud construction parameter required by the distributor, which may be considered as a customized parameter for the distributor, for example, a network domain (Domain Name) corresponding to a private cloud (Virtual Private Cloud (VPC)), a login picture (logo) presented when a relevant user logs in to the private cloud by using an apparatus thereof, hardware/software of the distributor, or information about a relevant apparatus.

The public cloud management device 200 defines a network resource on the public cloud network 210 according to the distributor private cloud setting information, and sets the network resource according to the distributor private cloud setting information, so that the network resource becomes the virtual private cloud network 220 corresponding to the distributor private cloud setting information. The distributor can mount a network device related to a service on the virtual private cloud network 220 of the distributor, so as to effectively serve clients.

However, in some embodiments, according to the architecture of the public cloud network 210 and differences between provided functions and permission requests, the distributor terminal apparatus 100 may also request, from the public cloud management device 200, monopolization of some particular resources or limited resources requiring a special permission on the public cloud network 210.

The public cloud management device 200 defines a private resource apparatus controlled and managed by the virtual private cloud network 220 among the network resource apparatuses (step S120). As mentioned above, the public cloud network 210 includes or manages a plurality of network resource apparatuses. In some embodiments, the network resource apparatuses at least include two types, one is computing resources (including software/hardware necessary for computing) used for cloud program computing, and the other is physical devices (211a, 211b, 211c, 211d, 211e, 211f, and 211g) mounted to the cloud. When the virtual private cloud network 220 is constructed, the computing resources are planned by the public cloud management device 200 according to a constructed rule or according to a corresponding operation rule generated according to the distributor private cloud setting information submitted by the distributor terminal apparatus 100, to be used by the virtual private cloud network 220. On the other hand, a distribution manner of physical devices at least includes the following manners:

(1) The physical devices (211a, 211b, 211c, 211d, 211e, 211f, and 211g) are mounted on the public cloud network 210. The public cloud management device 200 generates apparatus active codes of the physical devices (211a, 211b, 211c, 211d, 211e, 211f, and 211g). The distributor terminal apparatus 100 may apply to the public cloud management device 200 for a network resource apparatus to be occupied, for example, occupying the physical devices (211a, 211b, and 211c), and the public cloud management device 200 provides apparatus active codes of the physical devices (211a, 211b, and 211c) to a network device of the virtual private cloud network 220, or stores the apparatus active codes in the distributor terminal apparatus 100. Alternatively, the public cloud management device 200 provides three apparatus active codes to the network device of the virtual private cloud network 220, or stores the apparatus active codes in the distributor terminal apparatus 100, and after the apparatus active codes correspond to the physical devices (211a, 211b, and 211c), a correspondence result is returned to the public cloud management device 200 for storage. For example, when the distributor terminal apparatus 100 or a user terminal apparatus 101 logging in to the virtual private cloud network 220 intends to use the physical device 211a, it is determined, on the public cloud network 210 and the virtual private cloud network 220 (or the distributor terminal apparatus 100, or the user terminal apparatus 101) through identification of an apparatus active code, whether the physical device 211a is a private resource apparatus that can be controlled and managed by the virtual private cloud network 220. If yes, the distributor terminal apparatus 100 or the user terminal apparatus 101 logging in to the virtual private cloud network 220 can use the private resource apparatus; otherwise, the distributor terminal apparatus 100 or the user terminal apparatus 101 logging in to the virtual private cloud network 220 cannot use the private resource apparatus. Therefore, a private resource apparatus that can be controlled by each virtual private cloud network 220 can be defined by using an apparatus active code.

(2) The distributor terminal apparatus 100 may apply to the public cloud management device 200 for an intended number of physical devices, for example, three physical devices. The public cloud management device 200 provides three apparatus active codes to the network device of the virtual private cloud network 220, or to the distributor terminal apparatus 100. A manager of the private cloud may mount, by managing the network device of the virtual private cloud network 220 or the distributor terminal apparatus 100, necessary physical devices, for example, physical devices (211a and 211b), on the virtual private cloud network 220, and during the mounting, set the possessed apparatus active codes corresponding to the mounted physical devices (211a and 211b). An apparatus active code that is not used may be reserved for future use. Mounting data of the physical devices (211a and 211b) may be returned to the public cloud management device 200 for future reference and use.

Either of the implementation manners, the devices being mounted on the public cloud or being provided by an applicant of the virtual private cloud network 220, can be used to define, by using a link of an apparatus active code, a private resource apparatus that can be controlled by each virtual private cloud network 220.

However, the public cloud management device 200 may generate/set the apparatus active code according to a private cloud name corresponding to the virtual private cloud network 220, but it is not limited to using a private cloud name as a data computing reference. Moreover, the cloud name and the network domain name of the virtual private cloud network 220 are recorded in the distributor private cloud setting information, or are generated by the public cloud management device 200 spontaneously. In some embodiments, the public cloud management device 200 further generates a direct communication active code (P2P active code) for implementing a point-to-point connection to a private resource apparatus. The P2P active code may be stored in the public cloud management device 200 and the network device of the virtual private cloud network 220. Still using the network resource apparatus 211a as an example, the distributor terminal apparatus 100 or the user terminal apparatus 101 logging in to the virtual private cloud network 220 directly acquires a location of the network resource apparatus 211a by direct use of the P2P active code and interpretation of a program on the code, so as to form a P2P connection to the network resource apparatus 211a.

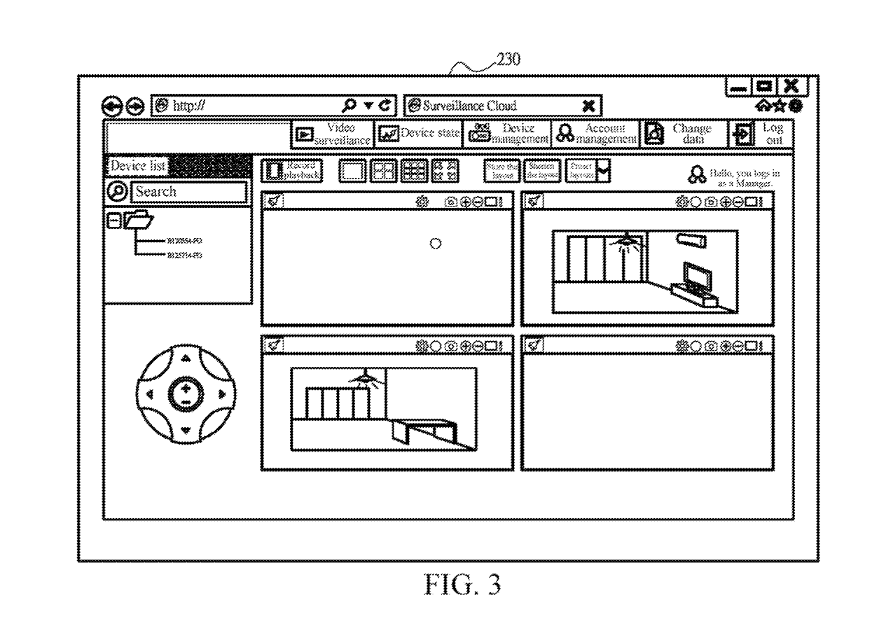

Further refer to FIG. 3, which is a schematic diagram of an apparatus management interface according to an embodiment of the present invention. No matter which communication manner is used, a network device logging in to the virtual private cloud network 220 can perform state monitoring, apparatus management and parameter setting on a private resource apparatus thereof by using a management interface 230 of the virtual private cloud network 220. However, according to different permissions, the distributor terminal apparatus 100 and the user terminal apparatus 101 have different login windows, and the management interface may be partitioned for presentation according to requirements of designers, and certainly, functions that can be used by the distributor terminal apparatus 100 and the user terminal apparatus 101 differ due to different permissions. For example, as shown in FIG. 3, the virtual private cloud network 220 has two private resource apparatuses, and running states or parameter presentation and setting of each private resource apparatus may be monitored by the manager by using multiple pictures/a partitioned picture or multiple windows.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A distributor private cloud management system, comprising:
a cluster device, configured to provide a public cloud network; and
a public cloud management device, connected to the cluster device and configured to manage the public cloud network, wherein the public cloud network comprises a plurality of network resource apparatuses, the public cloud management device plans, in the public cloud network according to distributor private cloud setting information, a virtual private cloud network corresponding to the distributor private cloud setting information, and defines a private resource apparatus controlled and managed by the virtual private cloud network among the network resource apparatuses.

2. The distributor private cloud management system according to claim 1, wherein the public cloud management device sets an apparatus active code of the private resource apparatus according to a private cloud name corresponding to the virtual private cloud network.

3. The distributor private cloud management system according to claim 2, wherein the cloud name is recorded in the distributor private cloud setting information, or generated by the public cloud management device spontaneously.

4. The distributor private cloud management system according to claim 1, wherein the public cloud management device constructs a domain name corresponding to the virtual private cloud network, and the domain name is recorded in the distributor private cloud setting information, or generated by the public cloud management device spontaneously.

5. The distributor private cloud management system according to claim 1, wherein the public cloud management device further generates a direct communication active code for implementing a point-to-point connection to the private resource apparatus.

6. A distributor private cloud management method, applicable to a public cloud management device, and used to manage a public cloud network provided by a cluster device, wherein the public cloud network comprises a plurality of network resource apparatuses, the method comprising:
planning, by the public cloud management device in the public cloud network according to distributor private cloud setting information input externally, a virtual private cloud network corresponding to the distributor private cloud setting information; and
defining, by the public cloud management device, a private resource apparatus controlled and managed by the virtual private cloud network among the network resource apparatuses.

7. The distributor private cloud management method according to claim 6, wherein the public cloud management device sets an apparatus active code of the private resource apparatus according to a cloud name corresponding to the virtual private cloud network.

8. The distributor private cloud management method according to claim 7, wherein the cloud name is recorded in the distributor private cloud setting information, or generated by the public cloud management device spontaneously.

9. The distributor private cloud management method according to claim 6, wherein the public cloud management device constructs a domain name corresponding to the virtual private cloud network, and the domain name is recorded in the distributor private cloud setting information, or generated by the public cloud management device spontaneously.

10. The distributor private cloud management method according to claim 6, wherein the public cloud management device further generates a direct communication active code for implementing a point-to-point connection to the private resource apparatus.
